(19) United States
(12) Patent Application Publication
(10) Pub. No.: US 2019/0140553 A1
(43) Pub. Date: May 9, 2019

(54) AC/DC CONVERTER, MODULE, POWER CONVERSION DEVICE, AND AIR CONDITIONING APPARATUS

(71) Applicant: Mitsubishi Electric Corporation, Tokyo (JP)

(72) Inventors: Keiichiro SHIZU, Tokyo (JP); Yosuke SHINOMOTO, Tokyo (JP)

(21) Appl. No.: 16/095,795

(22) PCT Filed: Jul. 28, 2016
(86) PCT No.: PCT/JP2016/072134

§ 371 Date: Oct. 23, 2018

(51) Int. Cl. H02M 7/06; H02M 5/458; H02P 27/06; F25B 49/02

(52) U.S. Cl. CPC H02M 7/06; H02M 5/4585; F25B 2600/0253; F25B 49/022; F25B 2700/2104; H02P 27/06

(57) ABSTRACT

An AC/DC converter includes a first rectifier and a second rectifier each coupled to an AC power supply through the reactor; a switch arm, which includes two switches coupled in series with each other, arranged on an output side of the first rectifier; and two capacitors coupled in series with each other arranged on an output side of the second rectifier. A connection point between the two capacitors is coupled to a connection point between the two switches. Thus, the space for mounting circuit components can be reduced.

### CROSS REFERENCE TO RELATED APPLICATION

This application is a U.S. national stage application of International Patent Application No. PCT/JP2016/072134 filed on Jul. 28, 2016, the disclosure of which is incorporated herein by reference.

### TECHNICAL FIELD

The present invention relates to an alternating current to direct current (AC/DC) converter, a module, a power conversion device, and an air conditioning apparatus that each convert an alternating current (AC) voltage into a direct current (DC) voltage.

### BACKGROUND

The AC/DC converter disclosed in Patent Literature 1 includes, as a circuit that converts a single-phase AC voltage into a DC voltage, a first rectifier and a second rectifier coupled through a reactor to an AC power supply, two capacitors coupled in series with each other between output terminals of the first rectifier, and two switches coupled in series with each other between output terminals of the second rectifier. A connection point between the two capacitors is connected to a connection point between the two switches. The first rectifier and the second rectifier are each an independent module. The AC/DC converter disclosed in Patent Literature 1 includes two switches coupled in series with each other in addition to these modules. The AC/DC converter disclosed in Patent Literature 1 regards the two capacitors coupled in series with each other as a virtual AC power supply, and then controls the two switches to reduce harmonic current and to cause zero phase difference. This control provides a sinusoidal input current in which harmonic components are reduced as an AC current supplied from the AC power supply to the AC/DC converter, thereby increasing the power factor.

### Patent Literature

Patent Literature 1: Japanese Patent Application Laid-open No. 2011-250694

However, the AC/DC converter disclosed in Patent Literature 1 includes the two rectifiers and the two switches as separate modules, thereby presents a problem in that increased space for accommodating these components in the AC/DC converter is required.

### SUMMARY

The present invention has been made in view of the foregoing, and it is an object of the present invention to provide an AC/DC converter that can reduce the space for mounting circuit components.

An alternating current to direct current (AC/DC) converter according to an aspect of the present invention includes: a first rectifier and a second rectifier each coupled through a reactor to an alternating current (AC) power supply; a switch arm including two switches coupled in series with each other arranged on an output side of the first rectifier; and two capacitors coupled in series with each other arranged on an output side of the second rectifier, wherein a connection point between the two capacitors is coupled to a connection point between the two switches.

An AC/DC converter according to the present invention is advantageous in that the space for mounting circuit components can be reduced.

### BRIEF DESCRIPTION OF DRAWINGS

FIG. 1 is a diagram illustrating an example configuration of an AC/DC converter according to a first embodiment of the present invention.

FIG. 2 is a diagram illustrating an internal circuit configuration of a reference circuit module used in a bridge inverter.

FIG. 3 is a diagram illustrating a variation of the AC/DC converter according to the first embodiment of the present invention.

FIG. 4 is a diagram illustrating an example configuration of an AC/DC converter according to a second embodiment of the present invention.

FIG. 5 is a configuration diagram of a power conversion device formed by connection of an inverter to the AC/DC converter according to the second embodiment of the present invention.

FIG. 6 is a diagram illustrating a variation of the AC/DC converter according to the second embodiment of the present invention.

FIG. 7 is a diagram illustrating a first variation of a module included in the AC/DC converter according to the second embodiment of the present invention.

FIG. 8 is a diagram illustrating another variation of the AC/DC converter according to the second embodiment of the present invention.

FIG. 9 is a diagram illustrating a second variation of the module included in the AC/DC converter according to the second embodiment of the present invention.

FIG. 10 is a configuration diagram of an air conditioning apparatus according to a fifth embodiment of the present invention.

### DETAILED DESCRIPTION

An AC/DC converter, a module, a power conversion device, and an air conditioning apparatus according to embodiments of the present invention will be described in detail below with reference to the drawings. Note that these embodiments are not intended to limit the scope of this invention.

### First Embodiment

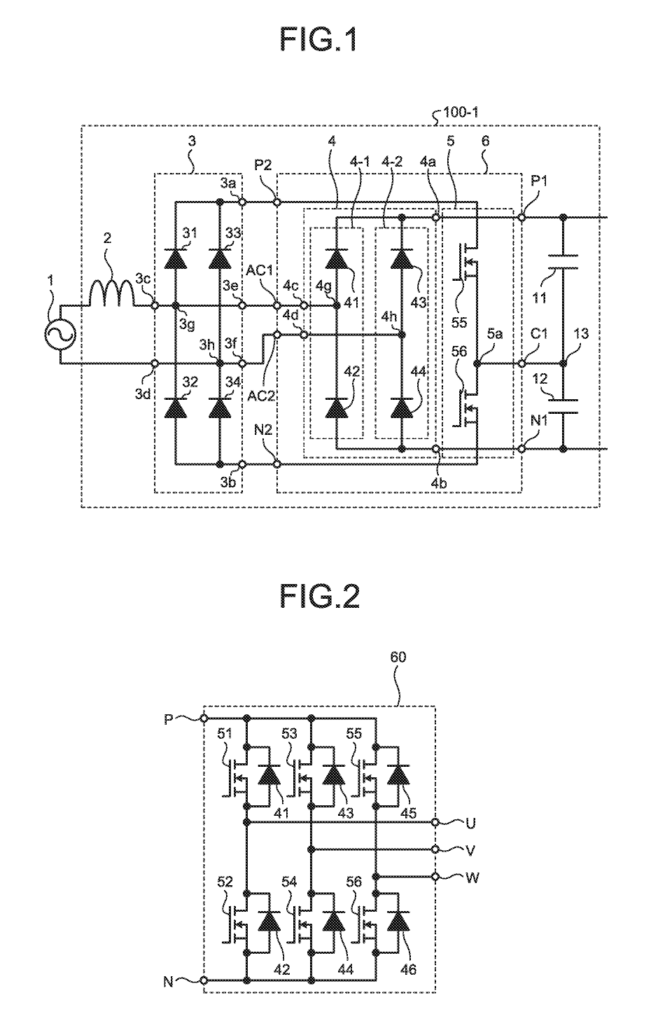

FIG. 1 is a diagram illustrating an example configuration of an AC/DC converter according to a first embodiment of the present invention. An AC/DC converter 100-1 according to the first embodiment includes a reactor 2 having one end coupled to one end of an AC power supply 1; a first rectifier 3, coupled through the reactor 2 to the AC power supply 1, that converts AC power supplied from the AC power supply 1 into DC power; and a second rectifier 4, which is coupled through the reactor 2 to the AC power supply 1, that converts AC power supplied from the AC power supply 1 into DC power. In FIG. 1, the AC power supply 1 outputs a single-phase AC voltage.

The AC/DC converter 100-1 also includes a switch arm 5, which is a series circuit including a switch 55 and a switch 56 coupled in series with each other between an output terminal 3a and an output terminal 3b included in the first rectifier 3; and a capacitor pair including a capacitor 11 and a capacitor 12 coupled in series with each other between an output terminal 4a and an output terminal 4b included in the second rectifier 4.

The switch 55 may be, for example, a semiconductor switch, such as an insulated gate bipolar transistor (IGBT), a metal oxide semiconductor field effect transistor (MOSFET) being an example of field effect transistor, an insulated gate controlled thyristor (IGCT), or a field effect transistor (FET). The switch 56 is a same or similar type of component. The switch 55 and the switch 56 of the first embodiment are each formed of an N-channel MOSFET. The MOSFET of each of the switch 55 and the switch 56 has a gate coupled with a drive circuit (not illustrated) for driving the corresponding switch 55 or the switch 56.

The second rectifier 4 and the switch arm 5 are integrated together to form a module 6. The module 6 includes an output terminal P1, an output terminal N1, and an output terminal C1; and an input terminal P2, an input terminal N2, an input terminal AC1, and an input terminal AC2.

The input terminal P2 of the module 6 is coupled with the drain of the MOSFET that is the switch 55, and with the output terminal 3a of the first rectifier 3. The input terminal N2 of the module 6 is coupled with the source of the MOSFET that is the switch 56, and with the output terminal 3b of the first rectifier 3. The output terminal C1 of the module 6 is coupled with a connection point 5a between the switch 55 and the switch 56 included in the switch arm 5.

The first rectifier 3 includes the output terminal 3a and the output terminal 3b; an input terminal 3c and an input terminal 3d; a relay terminal 3e and a relay terminal 3f; and a diode 31, a diode 32, a diode 33, and a diode 34. The relay terminal 3e of the first rectifier 3 is coupled to the input terminal AC1 of the module 6. The relay terminal 3f of the first rectifier 3 is coupled to the input terminal AC2 of the module 6.

The anode of the diode 31 and the cathode of the diode 32 are coupled to each other at a connection point 3g, and the connection point 3g is coupled to the input terminal 3c and to the relay terminal 3e. The input terminal 3c is coupled to another end of the reactor 2 and to the connection point 3g. The anode of the diode 33 and the cathode of the diode 34 are coupled to each other at a connection point 3h, and the connection point 3h is coupled to the input terminal 3d and to the relay terminal 3f. The input terminal 3d is coupled to another end of the AC power supply 1 and to the connection point 3h.

The cathode of each of the diode 31 and the diode 33 is coupled to the output terminal 3a, and the anode of each of the diode 32 and the diode 34 is coupled to the output terminal 3b.

The second rectifier 4 includes the output terminal 4a and the output terminal 4b; an input terminal 4c and an input terminal 4d; and a diode 41, a diode 42, a diode 43, and a diode 44. The diode 41, the diode 42, the diode 43, and the diode 44 may also be hereinafter referred to simply as diodes 41, 42, 43, and 44.

The anode of the diode 41 and the cathode of the diode 42 are coupled to each other at a connection point 4g, and the connection point 4g is coupled to the input terminal 4c. The input terminal 4c is coupled to the input terminal AC1 of the module 6. The anode of the diode 43 and the cathode of the diode 44 are coupled to each other at a connection point 4h, and the connection point 4h is coupled to the input terminal 4d. The input terminal 4d is coupled to the input terminal AC2 of the module 6.

The cathode of each of the diode 41 and the diode 43 is coupled to the output terminal 4a, and the anode of each of the diode 42 and the diode 44 is coupled to the output terminal 4b. The output terminal 4a of the second rectifier 4 is coupled to the output terminal P1 of the module 6, while the output terminal 4b of the second rectifier 4 is coupled to the output terminal N1 of the module 6.

The capacitor 11 has one end coupled to the output terminal P1 of the module 6. Another end of the capacitor 11 and one end of the capacitor 12 are coupled to each other at a connection point 13. The connection point 13 is coupled to the output terminal C1 of the module 6. The capacitor 12 has another end coupled to the output terminal N1 of the module 6.

As described above, the AC/DC converter 100-1 is configured such that the first rectifier 3 and the second rectifier 4 are each coupled through the reactor 2 to the AC power supply 1, and the connection point 5a between the switch 55 and the switch 56 and the connection point 13 between the capacitor 11 and the capacitor 12 are coupled to each other through the output terminal C1 of the module 6.

The first rectifier 3 is a single module separate from the module 6. The first rectifier 3 operates as a full wave rectifier. The module 6 is another single module in which the second rectifier 4 and the switch arm 5 are integrated together. In the second rectifier 4, the diodes 41, 42, 43, and 44 form two rectification arms, and the second rectifier 4 operates as a full wave rectifier.

The module 6 includes three arms, including the switch arm 5. That is, the module 6 includes a first diode arm 4-1 including the diode 41 and the diode 42, a second diode arm 4-2 including the diode 43 and the diode 44, and the switch arm 5, as a third switch arm, including the switch 55 and the switch 56. The module 6 includes seven external connection terminals, i.e., the input terminal P2, the input terminal AC1, the input terminal AC2, the input terminal N2, the output terminal P1, the output terminal N1, and the output terminal Cl.

Similarly to conventional AC/DC converters represented by that of Patent Literature 1 described above, the AC/DC converter 100-1 is configured to control on and off operations of the switch 55 and of the switch 56. This control provides a sinusoidal current in which harmonic components are reduced as the AC current supplied from the AC power supply 1 to the AC/DC converter 100-1, and thus reduces the phase difference with respect to the AC voltage applied from the AC power supply 1 to the AC/DC converter 100-1, thereby increasing the power factor.

The AC/DC converter 100-1 turns on one of the switch 55 and the switch 56, and turns off the other of the switch 55 and the switch 56 to cause the connection point 13 between the capacitor 11 and the capacitor 12 to be coupled to one end or to another end of the AC power supply 1, thus to provide so-called voltage doubler rectification. Thus, the amplitude of the voltage applied across both ends of the series circuit including the capacitor 11 and the capacitor 12, i.e., the amplitude of the output voltage of the AC/DC converter 100-1, becomes greater than the amplitude of the voltage applied across the input terminal P2 and the input terminal N2 of the module 6, or the amplitude of the voltage applied across the input terminal AC1 and the input terminal AC2. Note that the voltage applied across the input terminal P2 and the input terminal N2 of the module 6, or the voltage applied across the input terminal AC1 and the input terminal AC2 may also be hereinafter referred to as “input voltage”.

In addition, the AC/DC converter 100-1 uses two modules to implement the first rectifier 3, the second rectifier 4, and the switch arm 5. Thus, as compared to a case in which the first rectifier 3, the second rectifier 4, and the switch arm 5 are mounted inside the AC/DC converter 100-1 as separate modules, the AC/DC converter 100-1 can reduce the mount space for arranging the first rectifier 3, the second rectifier 4, and the switch arm 5 inside the AC/DC converter 100-1. This enables size reduction of the AC/DC converter 100-1, and also reduction in the material volume of the components, such as the housing that forms the outer shell of the AC/DC converter 100-1, and the substrate for mounting the module 6.

Turning on the switch 55 causes a current to flow through the switch 55, and a current does not flow through the diode 41 and the diode 43. Similarly, when the switch 56 is turned on, a current does not flow through the diode 42 and the diode 44. As such, the module 6 is configured such that the number of elements through which a current flows at one time is two among the switches and in the diodes included in the module 6. This can reduce the amount of heat generated by the module 6, and can thus reduce the sizes of heat dissipation components such as a heat sink and a fan (not illustrated) for releasing heat generated in the module 6.

FIG. 2 is a diagram illustrating an internal circuit configuration of a reference circuit module used in a bridge inverter. A reference circuit module 60 illustrated in FIG. 2 is a module for providing a typical, conventional three-phase inverter circuit. The reference circuit module 60 includes five external connection terminals, i.e., an input terminal P, an input terminal N, an output terminal U, an output terminal V, and an output terminal W. The reference circuit module 60 also includes a switch 51, a switch 52, a switch 53, a switch 54, the switch 55, and the switch 56. The reference circuit module 60 further includes the diode 41, the diode 42, the diode 43, the diode 44, a diode 45, and a diode 46 coupled in parallel respectively to the switch 51, the switch 52, the switch 53, the switch 54, the switch 55, and the switch 56.

The module 6 illustrated in FIG. 1 differs from the reference circuit module 60 as follows.

(1) The module 6 does not include the diode 45, the diode 46, the switch 51, the switch 52, the switch 53, and the switch 54 included in the reference circuit module 60.

(2) The module 6 includes the seven external connection terminals, i.e., the input terminal P2, the input terminal AC1, the input terminal AC2, the input terminal N2, the output terminal P1, the output terminal N1, and the output terminal C1, instead of the five external connection terminals included in the reference circuit module 60, i.e., the input terminal P, the input terminal N, the output terminal U, the output terminal V, and the output terminal W. In this configuration, the input terminal AC1 of the module 6 corresponds to the output terminal U of the reference circuit module 60; the input terminal AC2 of the module 6 corresponds to the output terminal V of the reference circuit module 60; and the output terminal C1 of the module 6 corresponds to the output terminal W of the reference circuit module 60. Addition of the input terminal P2 and the input terminal N2 illustrated in FIG. 1 to the reference circuit module 60 would produce the module 6.

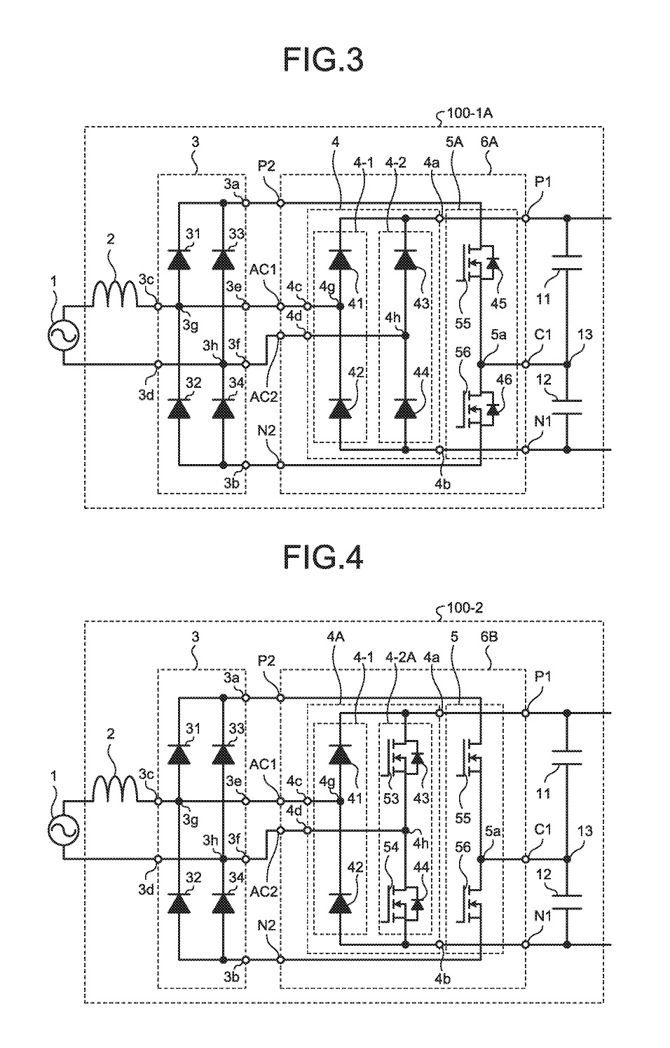

FIG. 3 is a diagram illustrating a variation of the AC/DC converter according to the first embodiment of the present invention. An AC/DC converter 100-1A illustrated in FIG. 3 differs from the AC/DC converter 100-1 illustrated in FIG. 1 as follows.

(1) The AC/DC converter 100-1A includes a switch arm 5A and a module 6A in place of the switch arm 5 and the module 6 illustrated in FIG. 1.

(2) The switch arm 5A includes, in addition to the switch 55 and the switch 56, the diode 45 coupled in parallel with the switch 55 in which a current flows in a direction opposite to a current flowing through the switch 55, and the diode 46 coupled in parallel with the switch 56 in which a current flows in a direction opposite to a current flowing through the switch 56.

The anode of the diode 45 is coupled to the source of the switch 55, and the cathode of the diode 45 is coupled to the drain of the switch 55. The anode of the diode 46 is coupled to the source of the switch 56, and the cathode of the diode 46 is coupled to the drain of the switch 56.

If the switch 55 and the switch 56 are IGBTs, a reverse voltage applied to the emitter terminal, that is higher than a reverse voltage applied to the collector terminal of each of the switch 55 and the switch 56 may result in failure in blocking a reverse current in the switch 55 and/or in the switch 56. This will cause a high current to flow therethrough, thereby possibly causing the switch 55 and/or the switch 56 to overheat and fail.

Even in a case where such a reverse voltage is applied, the AC/DC converter 100-1A including the diode 45 and the diode 46 allows a current to flow through the diode 45 and the diode 46 to prevent a reverse voltage from being applied to the switch 55 and the switch 56, and can thus prevent failure of the switch 55 and the switch 56.

In addition, since the diode 45 and the diode 46 are mounted inside the reference circuit module 60 illustrated in FIG. 2, the AC/DC converter 100-1A can provide the module 6A without a need for additional space for mounting the diode 45 and the diode 46 inside or outside the module 6A illustrated in FIG. 3.

If the switch 55 and the switch 56 are MOSFETs, diodes in each of which a current flows in a direction opposite to a current flowing through corresponding one of the switch 55 and the switch 56 are produced during production thereof. Thus, the switch 55 and the diode 45 together have a configuration equivalent to one MOSFET. A same or similar principle applies to the combination of the switch 56 and the diode 46. Therefore, the AC/DC converter 100-1A can provide the module 6A without addition of the diode 45 and the diode 46.

Transition of the switch 55 and/or the switch 56 from an “on” state to an “off” state causes a high reverse recovery current to flow through the diode 45 and/or the diode 46. This reverse recovery current may cause the switch 55 and/or the switch 56 to overheat. To prevent this, the module 6 illustrated in FIG. 1 and the module 6A illustrated in FIG. 3 desirably use the switch 55 and the switch 56 formed using a wide bandgap semiconductor. Examples of wide bandgap semiconductor include semiconductor materials such as silicon carbide (SiC), gallium nitride, and diamond. The reverse recovery time of a wide bandgap semiconductor is significantly shorter than the reverse recovery time of a silicon semiconductor, and the reverse recovery current is also very low.

An SiC Schottky barrier diode having a reverse voltage rating of 600 V and a forward current rating of 6 A has a reverse recovery charge of 20 nC, which is significantly lower than the reverse recovery charge of a typical silicon PN junction diode ranging from 150 nC to 1500 nC. Use of a wide bandgap semiconductor also enables an AC/DC converter utilizing the reference circuit module 60 illustrated in FIG. 2 to significantly reduce heat generation due to a reverse recovery current in the switch 55 and the switch 56, thereby enabling the size of heat dissipation component to be reduced.

In addition, use of a wide bandgap semiconductor reduces the amount of heat transferred to components other than the switch 55 and the switch 56, of the heat generated in the switch 55 and in the switch 56, as compared to a case in which a silicon semiconductor is used. Accordingly, even when the switch 55 and the switch 56 are included inside the AC/DC converters 100-1 and 100-1A, the AC/DC converters 100-1 and 100-1A can reduce the possibility of failure of a component other than the switch 55 and the switch 56 due to heat generated by the switch 55 and by the switch 56. The AC/DC converters 100-1 and 100-1A can also reduce the possibility of failure of a component other than the switch 55 and the switch 56 due to heat generated by the switch 55 and by the switch 56 even when the sizes of the module 6 and of the module 6A are reduced.

### Second Embodiment

FIG. 4 is a diagram illustrating an example configuration of an AC/DC converter according to a second embodiment of the present invention. An AC/DC converter 100-2 according to the second embodiment differs from the AC/DC converter 100-1 according to the first embodiment as follows.

(1) The AC/DC converter 100-2 includes a module 6B in place of the module 6 illustrated in FIG. 1 or the module 6A illustrated in FIG. 3.

(2) The module 6B includes a second rectifier 4A in place of the second rectifier 4.

(3) The second rectifier 4A includes a second diode arm 4-2A in place of the second diode arm 4-2.

The second diode arm 4-2A includes the switch 53 and the switch 54 in addition to the diode 43 and the diode 44. The drain of the switch 53 is coupled to the cathode of the diode 41 and to the output terminal 4a. The source of the switch 54 is coupled to the anode of the diode 42 and to the output terminal 4b. The source of the switch 53 and the drain of the switch 54 are coupled to each other at the connection point 4h, and the connection point 4h is coupled to the input terminal 4d. The anode of the diode 43 is coupled to the source of the switch 53, and the cathode of the diode 43 is coupled to the drain of the switch 53. The anode of the diode 44 is coupled to the source of the switch 54, and the cathode of the diode 44 is coupled to the drain of the switch 54.

An operation of the AC/DC converter 100-2 will next be described. Similarly to the operation of the first embodiment, the AC/DC converter 100-2 can provide voltage doubler rectification by turning on of one of the switch 55 and the switch 56, and turning off of the other one of the switch 55 and the switch 56. In addition, the AC/DC converter 100-2 controls on and off operations of the switch 53 and of the switch 54.

By providing control of the switch 53, the switch 54, the switch 55, and the switch 56, the AC/DC converter 100-2 can increase the DC voltage using energy stored in the reactor 2, and also provides a sinusoidal current in which harmonic components are reduced in the AC current supplied to the AC/DC converter 100-2. This reduces the phase difference with respect to the AC voltage, thereby increasing the power factor. Note that if voltage doubler rectification by the switch 53 and the switch 54 is not performed, the DC voltage output from the AC/DC converter 100-2 is controlled to have a lower value than the value when voltage doubler rectification is performed by the switch 53 and the switch 54.

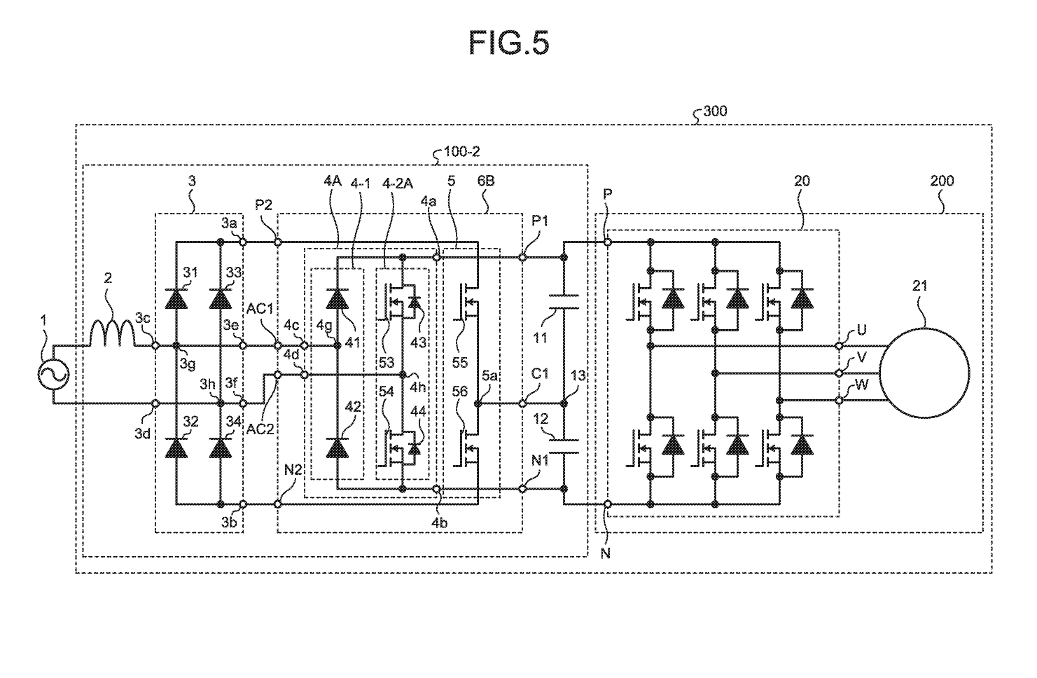

FIG. 5 is a configuration diagram of a power conversion device configured by connecting an inverter to the AC/DC converter according to the second embodiment of the present invention. A power conversion device 300 illustrated in FIG. 5 includes the AC/DC converter 100-2 illustrated in FIG. 4 and a load 200. The load 200 includes an inverter 20 coupled to the AC/DC converter 100-2, and an electric motor 21 driven by an AC voltage output from the inverter 20. Examples of the electric motor 21 include an induction motor and a synchronous motor.

The inverter 20 is configured similarly to the reference circuit module 60 illustrated in FIG. 2. The inverter 20 converts a DC voltage applied across both ends of the series circuit including the capacitor 11 and the capacitor 12 into an AC voltage to drive the electric motor 21. The AC voltage applied to the electric motor 21 has a sinusoidal waveform to reduce or prevent pulsation of the electric motor 21.

Since an increase in the rotational speed of the electric motor 21 increases the counter electromotive force generated at an AC voltage-applied terminal (not illustrated), the inverter 20 is controlled to adjust the amplitude of the AC voltage depending on the rotational speed of the electric motor 21.

When an amplitude of the DC voltage applied across both ends of the series circuit including the capacitor 11 and the capacitor 12 is smaller than the magnitude of the AC voltage applied to the electric motor 21, the inverter 20 fails to output a sinusoidal AC voltage, but instead, outputs a quasi-AC voltage containing a harmonic component. This causes the harmonic component to also be added onto a current flowing through the electric motor 21. This may result in not only pulsation of the electric motor 21, but also an increase in the amplitude of the current, thereby increasing the amount of heat generation due to on-state resistances of the switches and of the diodes included in the inverter 20. Thus, the inverter 20 requires circuit components resistant to such increase in the amount of heat generation, or otherwise, requires a larger heat dissipation component.

The AC/DC converter 100-2 according to the second embodiment controls the switch 55 and the switch 56 to provide voltage doubler rectification, thereby enabling the amplitude of the voltage applied across both ends of the series circuit including the capacitor 11 and the capacitor 12 to become greater than the amplitude of the input voltage. Thus, even when a rotational speed of the electric motor 21 is higher as compared to when no voltage doubler rectification is performed by the switch 53 and the switch 54, the inverter 20 can output a sinusoidal voltage, thereby successfully reducing or preventing pulsation of the electric motor 21, and reducing heat generation of the inverter 20.

Meanwhile, if the amplitude of the voltage of the counter electromotive force described above is less than the amplitude of the input voltage, the switch 55 and the switch 56 are controlled to provide voltage doubler rectification, or even if the switch 53 and the switch 54 are controlled to perform a rectification operation, the inverter 20 can output a sinusoidal voltage.

When a switch included in the inverter 20 transitions from an “on” state to an “off” state, heat generated due to the reverse recovery current flows through the corresponding diode included in the inverter 20, has an amount proportional to the voltage applied to the switch and to the diode included in the inverter 20. The magnitude of this voltage is equal to the magnitude of the DC voltage applied across both ends of the series circuit including the capacitor 11 and the capacitor 12. In addition, as described above, if the amplitude of the voltage of the counter electromotive force is less than the amplitude of the input voltage, the switch 53 and the switch 54 are controlled to perform a rectification operation, which is not voltage doubler rectification. This causes the magnitude of the DC voltage applied across both ends of the series circuit including the capacitor 11 and the capacitor 12 to be less than the magnitude when voltage doubler rectification is performed. Thus, in the power conversion device 300, the voltage applied to the switch and to the diode included in the inverter 20 is reduced, thereby reducing the amount of heat generated by the reverse recovery current flowing through the diode included in the inverter 20.

Moreover, the AC/DC converter 100-2 provides on-off control of the switch 53 and of the switch 54 based on a frequency that varies in synchronization with the voltage cycle of the AC power supply 1. Thus, the switch 53 and the switch 54 generate less heat, thereby enabling the amount of heat generated in the entire power conversion device 300 to be reduced.

Since the switch 53 and the switch 54 are also components forming the reference circuit module 60 illustrated in FIG. 2, the AC/DC converter 100-2 can implement the first rectifier 3, the second rectifier 4A and the switch arm 5 by two modules in total similarly to the first embodiment. Thus, as compared to a case in which the first rectifier 3, the second rectifier 4A, and the switch arm 5 are mounted inside the AC/DC converter 100-2 as separate modules, the AC/DC converter 100-2 can reduce the mount space for arranging the first rectifier 3, the second rectifier 4A, and the switch arm 5 inside the AC/DC converter 100-2.

In addition, because the AC/DC converter 100-2 can reduce the amount of heat generated by the switch 53 and the switch 54, the AC/DC converter 100-2 enables to reduce the failure of a component other than the switch 53 and the switch 54 due to heat generated by the switch 53 and the switch 54 even when the switch 53 and the switch 54 are included inside the AC/DC converter 100-2.

Moreover, even if the module 6B including the switch 53 and the switch 54 is reduced in size, the AC/DC converter 100-2 can also reduce the possibility of failure of a component other than the switch 53 and the switch 54 due to heat generated by the switch 53 and the switch 54.

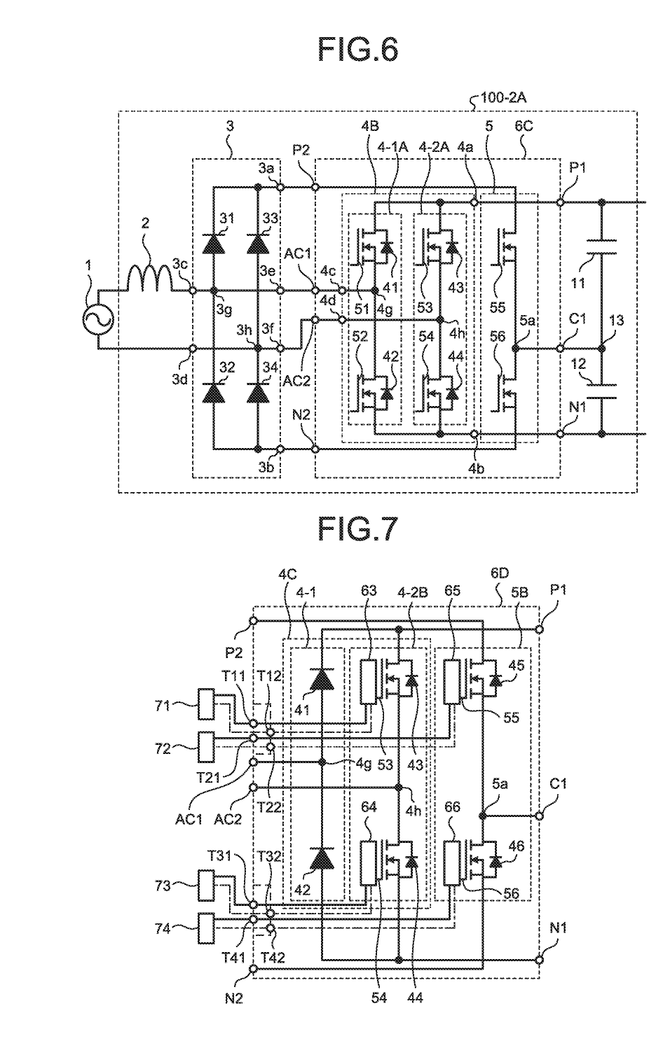

FIG. 6 is a diagram illustrating a variation of the AC/DC converter according to the second embodiment of the present invention. An AC/DC converter 100-2A illustrated in FIG. 6 differs from the AC/DC converter 100-2 illustrated in FIG. 4 as follows.

(1) The AC/DC converter 100-2A includes a module 6C in place of the module 6B.

(2) The module 6C includes a second rectifier 4B in place of the second rectifier 4A.

(3) The second rectifier 4B includes a first diode arm 4-1A in place of the first diode arm 4-1.

(4) The first diode arm 4-1A includes the switch 51 and the switch 52 in addition to the diode 41 and the diode 42.

The drain of the switch 51 is coupled to the cathode of the diode 41 and to the output terminal 4a. The source of the switch 52 is coupled to the anode of the diode 42 and to the output terminal 4b. The source of the switch 51 and the drain of the switch 52 are coupled to each other at the connection point 4g, and the connection point 4g is coupled to the input terminal 4c. The anode of the diode 41 is coupled to the source of the switch 51, and the cathode of the diode 41 is coupled to the drain of the switch 51. The anode of the diode 42 is coupled to the source of the switch 52, and the cathode of the diode 42 is coupled to the drain of the switch 52.

Even by use of the second rectifier 4B including the switch 51, the switch 52, the switch 53, and the switch 54 as illustrated in FIG. 6, the AC/DC converter 100-2A illustrated in FIG. 6 provides an advantage similar to the advantage provided by the AC/DC converter 100-2 including the switch 53 and the switch 54 illustrated in FIG. 4.

In addition to this advantage, the AC/DC converter 100-2A illustrated in FIG. 6 can provide control so that, when the AC power supply 1 is short circuited through the reactor 2 in a rectification operation, the short-circuit current is divided between the group of the switch 51 and the switch 53 and the group of the switch 52 and the switch 54. Accordingly, heat generated by the switch 51, the switch 52, the switch 53, and the switch 54 is dispersed, and thus the amount of heat generation can be reduced. This can reduce the size of a heat dissipation component (not illustrated) for releasing heat generated by the switch 51, the switch 52, the switch 53, and the switch 54.

### Third Embodiment

The module 6B of the second embodiment includes two switches, i.e., the switch 53 and the switch 54, and the module 6C of the second embodiment includes the switch 51, the switch 52, the switch 53, and the switch 54. However, the second embodiment does not take the characteristics of these switches into consideration. An AC/DC converter according to a third embodiment includes the switch 53 and the switch 54 that are each configured by a MOSFET. The AC/DC converter according to the third embodiment is configured similarly to the AC/DC converter 100-2 illustrated in FIG. 4 except that the switch 53 and the switch 54 are each configured by a MOSFET, and thus, the description of the third embodiment describes the configuration of the AC/DC converter according to the third embodiment with reference to FIG. 4.

As described above, during production of a MOSFET, a diode in which a current flows in a direction opposite to a current that flows through the MOSFET is produced. Thus, a combination of the switch 53 and the diode 43 has a configuration equivalent to one MOSFET, and a combination of the switch 54 and the diode 44 has a configuration equivalent to one MOSFET. This can realize a parallel circuit of the switch 53 and the diode 43 and a parallel circuit of the switch 54 and the diode 44 without addition of the diode 43 and the diode 44.

In addition, in a MOSFET, when a current flowing through a diode in which a current flows in a direction opposite to a current flowing through the switch included in that MOSFET, a voltage proportional to the magnitude of the current is generated across both ends of the switch. Thus, the amount of the heat generated by a MOSFET is derived from a product of the current and the voltage proportional to the current, that is, increases in proportion to the square of the current. If the second diode arm 4-2A illustrated in FIG. 4 does not include the switch 53 or the switch 54, a certain drop voltage VF is generated across both ends of each of the diode 43 and the diode 44, thereby causing even a low value of current to generate heat proportional to the drop voltage in the diode 43 and the diode 44. Accordingly, if a current flows through the switch 53 and the switch 54 in only a low amount, the heat generated by the switch 53 and the switch 54 can be further reduced as compared to a case when the diode 43 and the diode 44 are only used.

Now assume that the switch 53 and the switch 54 are each configured by a wide bandgap semiconductor, and the switch 55 and the switch 56 included in the switch arm 5 are each configured by a silicon semiconductor, in particular, an insulated gate bipolar transistor.

When the inverter 20 increases the amplitude of the AC voltage applied to the electric motor 21, and the inverter 20 also increases the output power of the inverter 20 to increase the rotational speed of the electric motor 21, performing voltage doubler rectification as described in relation to the second embodiment causes a current to flow through one of the switch 55 and the switch 56 because the switch 55 and the switch 56 that configure the switch arm 5 are provided. A drop voltage Vce becomes a constant value at a current having a certain value or higher in a silicon semiconductor, in particular, in an insulated gate bipolar transistor, heat that is generated when a current is flowing in a current direction through the switch 55 and the switch 56 in an amount proportional to the drop voltage. This is because of a characteristic where the heat generated by the switch 55 and the switch 56 is reduced when a high current flows though the switch 55 and the switch 56, while the amount of heat generated by a MOSFET is proportional to the square of the current.

When the inverter 20 reduces the amplitude of the AC voltage applied to the electric motor 21, and the inverter 20 also reduces the output power of the inverter 20 to reduce the rotational speed of the electric motor 21, controlling the switch 53 and the switch 54 to perform a rectification operation as described in relation to the second embodiment reduces the amount of heat generated by the switch 53 and the switch 54 as described in the second and third embodiments.

The AC/DC converter according to the third embodiment is configured such that the switch 53 and the switch 54 are each configured by a wide bandgap semiconductor, while the switch 55 and the switch 56 are each configured by an insulated gate bipolar transistor. The AC/DC converter according to the third embodiment selects either to control the switch 55 and the switch 56 to perform voltage doubler rectification, or to control the switch 53 and the switch 54 to perform a rectification operation, in accordance with the amplitude of the AC voltage applied from the inverter 20 to the electric motor 21 depending on the desired rotational speed of the electric motor 21. This control allows the switches to be selected that will generate less heat in both selection options, thereby enabling reduction in the heat generated by the switch 53, the switch 54, the switch 55, and the switch 56.

The AC/DC converter according to the third embodiment is also applicable to the power conversion device 300 illustrated in FIG. 5, which can further reduce the heat generated in the entire power conversion device 300 as compared to when the configuration of the second embodiment is used.

Since the switch 53 and the switch 54 are also components constituting the reference circuit module 60 illustrated in FIG. 2, the AC/DC converter according to the third embodiment can implement the first rectifier 3, the second rectifier 4A and the switch arm 5 by two modules in total similarly to the first embodiment. Thus, as compared to a case in which the first rectifier 3, the second rectifier 4A, and the switch arm 5 are mounted inside the AC/DC converter as separate modules, the AC/DC converter according to the third embodiment can reduce the mount space for arranging the first rectifier 3, the second rectifier 4A, and the switch arm 5 inside the AC/DC converter.

The AC/DC converter according to the third embodiment can reduce the heat generated by the switch 53, the switch 54, the switch 55, and the switch 56. Therefore, even when the switch 53, the switch 54, the switch 55, and the switch 56 are included inside the AC/DC converter, the AC/DC converter can reduce the possibility of failure of a component other than the switch 53, the switch 54, the switch 55, and the switch 56 due to heat generated by the switch 53, the switch 54, the switch 55, and the switch 56.

The AC/DC converter according to the third embodiment can also reduce the possibility of failure of a component other than the switch 53, the switch 54, the switch 55, and the switch 56 even when the module 6B including the switch 53, the switch 54, the switch 55, and the switch 56 are reduced in size.

### Fourth Embodiment

The description of the fourth embodiment describes a variation of the second embodiment. FIG. 7 is a diagram illustrating a module included in the AC/DC converter 100-4 according to the present embodiment of the present invention as a first variation of a module included in the AC/DC converter according to the second embodiment of the present invention. A module 6D illustrated in FIG. 7 differs from the module 6B illustrated in FIG. 4 as follows.

(1) The module 6D includes a second rectifier 4C in place of the second rectifier 4A. The module 6D also includes a switch arm 5B in place of the switch arm 5.

(2) The second rectifier 4C includes a second diode arm 4-2B in place of the second diode arm 4-2A. The second diode arm 4-2B includes a drive circuit 63 that drives the switch 53 and a drive circuit 64 that drives the switch 54 in addition to the diode 43, the diode 44, the switch 53, and the switch 54.

(3) The switch arm 5B includes a drive circuit 65 that drives the switch 55 and a drive circuit 66 that drives the switch 56 in addition to the diode 45, the diode 46, the switch 55, and the switch 56.

(4) The module 6D includes a positive power terminal T11 and a negative power terminal T12 for coupling, to the module 6D, a drive circuit power supply 71 serving as the power supply for driving the drive circuit 63. The module 6D also includes a positive power terminal T21 and a negative power terminal T22 for coupling, to the module 6D, a drive circuit power supply 72 serving as the power supply for driving the drive circuit 65. The module 6D also includes a positive power terminal T31 and a negative power terminal T32 for coupling, to the module 6D, a drive circuit power supply 73 serving as the power supply for driving the drive circuit 64. The module 6D also includes a positive power terminal T41 and a negative power terminal T42 for coupling, to the module 6D, a drive circuit power supply 74 serving as the power supply for driving the drive circuit 66.

The switch 53, the switch 54, the switch 55, and the switch 56 can be driven by a single power supply only when the drain terminals of these switches are coupled to one another to have a same potential. In this regard, the module 6D illustrated in FIG. 7 is configured such that all the drain terminals of these switches are each coupled to different external connection terminals. Thus, use of a single power supply for these switches is not possible, thereby requiring four power supplies, i.e., the drive circuit power supply 71, the drive circuit power supply 72, the drive circuit power supply 73, and the drive circuit power supply 74.

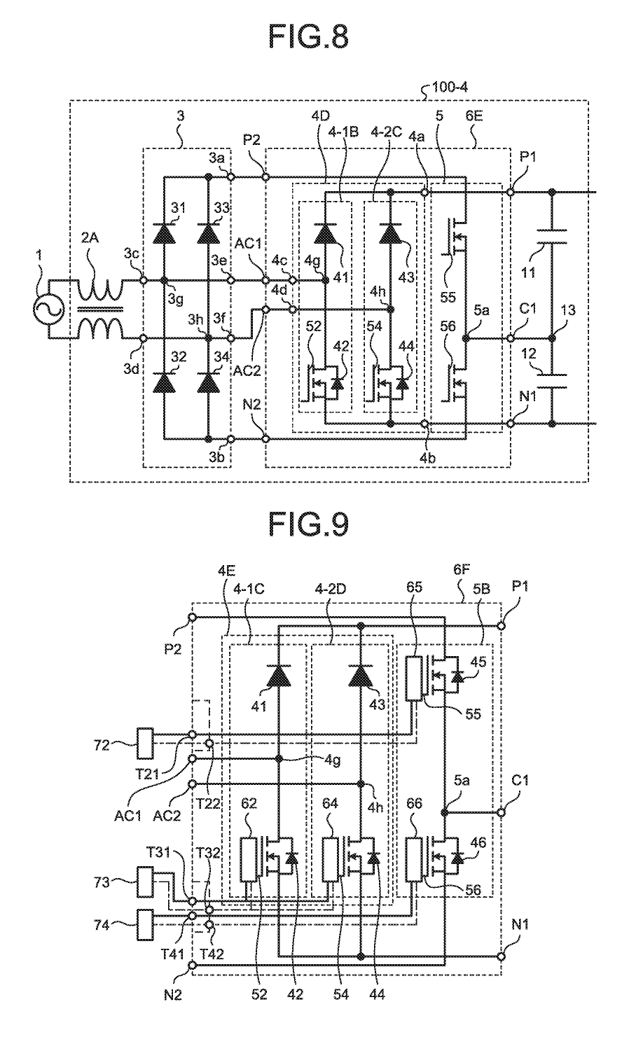

FIG. 8 is a diagram illustrating another variation of the AC/DC converter according to the second embodiment of the present invention. An AC/DC converter 100-4 illustrated in FIG. 8 differs from the AC/DC converter 100-2 illustrated in FIG. 4 as follows.

(1) The AC/DC converter 100-4 includes a reactor 2A in place of the reactor 2, and includes a module 6E in place of the module 6B.

(2) The module 6E includes a second rectifier 4D in place of the second rectifier 4A.

(3) The second rectifier 4D includes a first diode arm 4-1B in place of the first diode arm 4-1, and includes a second diode arm 4-2C in place of the second diode arm 4-2A.

The first diode arm 4-1B includes the switch 52 in addition to the diode 41 and the diode 42. The drain of the switch 52 is coupled to the cathode of the diode 42. The source of the switch 52 is coupled to the anode of the diode 42. The anode of the diode 41 and the drain of the switch 52 are coupled to each other at the connection point 4g, and the connection point 4g is coupled to the input terminal 4c. The second diode arm 4-2C does not include the switch 53 illustrated in FIG. 4. The diode 42 and the diode 44 have the anodes thereof coupled to each other.

FIG. 9 is a diagram illustrating a second variation of the module included in the AC/DC converter according to the second embodiment of the present invention. A module 6F illustrated in FIG. 9 differs from the module 6D illustrated in FIG. 7 as follows.

(1) The module 6F includes a second rectifier 4E in place of the second rectifier 4C.

(2) The second rectifier 4E includes a first diode arm 4-1C in place of the first diode arm 4-1, and includes a second diode arm 4-2D in place of the second diode arm 4-2B.

(3) The first diode arm 4-1C includes a drive circuit 62 that drives the switch 52 in addition to the diode 41 and the diode 42.

(4) The second diode arm 4-2D does not include the switch 53 or the drive circuit 63 illustrated in FIG. 7.

(5) The module 6F does not include the positive power terminal T11 or the negative power terminal T12 illustrated in FIG. 7. Each of the drive circuit 62 and the drive circuit 64 is coupled to both of the positive power terminal T31 and the negative power terminal T32.

The module 6F illustrated in FIG. 9 is configured such that the drain terminals of the switch 52 and of the switch 54 are both coupled to a same external connection terminal, i.e., the output terminal N1. Thus, the power supplies that each drive the switch 52 and the switch 54 may have a same potential. Accordingly, the drive circuit 62 and the drive circuit 64 can use a single drive circuit power supply, i.e., the drive circuit power supply 73, to drive the switch 52 and the switch 54, thereby reducing the number of required drive circuit power supplies to three, which is less than the number of the switches.

As described above, the AC/DC converter 100-4 of FIG. 9 that is the second variation of the fourth embodiment can use a common power supply for the drive circuits of the switch 52 and the switch 54, thereby enabling the number of required drive circuit power supplies to be reduced, and manufacturing cost to be thus reduced.

Similarly to the second embodiment, the AC/DC converter of the fourth embodiment provides control of the switch 55 and the switch 56 to perform voltage doubler rectification and control of the switch 52 and the switch 54, to provide a sinusoidal current in which harmonic components contained in the AC current supplied to the AC/DC converter 100-4 are reduced. This reduces the phase difference with respect to the AC voltage, thereby increasing the power factor.

In a case in which the AC/DC converter 100-4 according to the fourth embodiment is applied to the power conversion device 300 illustrated in FIG. 5, the DC voltage applied across both ends of the series circuit including the capacitor 11 and the capacitor 12 is converted into an AC voltage in the inverter 20; and then the AC/DC converter 100-4 selects to control the switch 55 and the switch 56 to perform voltage doubler rectification if the desired rotational speed of the electric motor 21 is controlled to be high, and to control the switch 52 and the switch 54 to perform a rectification operation if the desired rotational speed of the electric motor 21 is controlled to be low depending on the amplitude of the AC voltage applied from the inverter 20 to the electric motor 21. This enables the inverter 20 to generate less heat depending on the rotational speed of the electric motor 21, thereby enabling reduction in the size of heat dissipation component (not illustrated) for releasing the heat generated by the inverter 20.

Since the switch 52 and the switch 54 are also components constituting the reference circuit module 60 illustrated in FIG. 2, the AC/DC converter 100-4 according to the fourth embodiment can implement the modules 6D, 6E, and 6F without providing a mount space for arranging the switch 52 and the switch 54 inside or outside the modules 6D, 6E, and 6F.

In addition, the AC/DC converter 100-4 can reduce the possibility of failure of a component other than the switch 52 and the switch 54 due to heat generated by the switch 52 and the switch 54 even when the switch 52 and the switch 54 are included inside the AC/DC converter 100-4.

### Fifth Embodiment

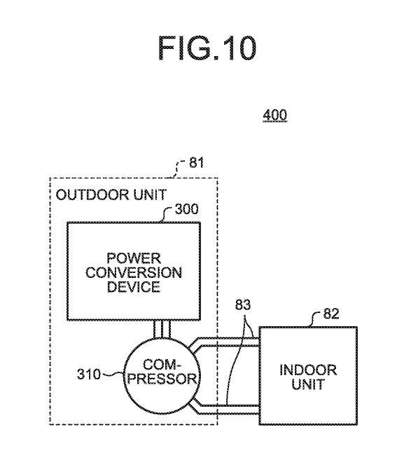

FIG. 10 is a configuration diagram of an air conditioning apparatus according to a fifth embodiment of the present invention. An air conditioning apparatus 400 illustrated in FIG. 10 includes an outdoor unit 81, an indoor unit 82, and a refrigerant pipes 83. The outdoor unit 81 and the indoor unit 82 are connected to each other through the refrigerant pipes 83. The outdoor unit 81 includes the power conversion device of any one of the first to fourth embodiments, and a compressor 310. The compressor 310 includes a compression mechanism not illustrated, and also includes the electric motor 21 illustrated in FIG. 5 as a drive source to drive the compression mechanism.

An operation of the air conditioning apparatus 400 will next be described. The indoor unit 82 stores a target temperature specified by a user, and detects a temperature near the indoor unit 82 and stores that temperature as a detection temperature. The indoor unit 82 sends the target temperature and the detection temperature to the outdoor unit 81. If target temperature information and detection temperature information stored in the indoor unit 82 significantly differ from each other, the outdoor unit 81 increases the amount of the refrigerant circulating between the outdoor unit 81 and the indoor unit 82 to cause the temperature near the indoor unit 82 to approach the target temperature. The amount of the refrigerant compressed by the compressor 310 is calculated as a product of the amount of discharged refrigerant per unit rotational speed of the compressor 310 and the rotational speed of the electric motor 21. Thus, to increase the amount of the refrigerant circulating between the outdoor unit 81 and the indoor unit 82, the outdoor unit 81 provides control to increase the rotational speed of the electric motor 21.

Meanwhile, when the difference between the target temperature and the detection temperature stored in the indoor unit 82 falls below a certain value, to prevent the detection temperature near the indoor unit 82 from reaching and exceeding much beyond the target temperature, the amount of the refrigerant circulating between the outdoor unit 81 and the indoor unit 82 is reduced. To this end, the outdoor unit 81 provides control to decrease the rotational speed of the electric motor 21.

In a continuous operation of the air conditioning apparatus 400, the operational time during which the target temperature and the detection temperature differ by less than a certain value is longer than the operational time during which the target temperature and the detection temperature differ by more than that value. Accordingly, in a large proportion of time, the air conditioning apparatus 400 provides control to maintain the rotational speed of the electric motor 21 at a low value to reduce the amount of the refrigerant circulating between the outdoor unit 81 and the indoor unit 82.

Meanwhile, as described in the second to fourth embodiments, the power conversion device 300 selects to perform either voltage doubler rectification or a standard rectification operation depending on the desired rotational speed of the electric motor 21 to provide control to reduce the amount of heat generation in both selection options. Specifically, if control is provided to maintain the desired rotational speed of the electric motor 21 at a low value, a standard rectification operation is selected to reduce the amount of heat generated by the power conversion device 300.

If the switch 51, the switch 52, the switch 53, and the switch 54 described above are each configured by a MOSFET, if the MOSFET is configured by a wide bandgap semiconductor, and the switch 55 and the switch 56 are each configured by a silicon semiconductor, in particular, an insulated gate bipolar transistor, the air conditioning apparatus 400 can obtain more advantageous effects as described in the third embodiment. When the air conditioning apparatus 400 performs control that has a large proportion of operational time and maintains the rotational speed of the electric motor 21 at a low value, the air conditioning apparatus 400 enables to reduce the amount of heat generated by the power conversion device 300, thereby enabling the operation efficiency to be improved in the entire time that includes the entire operation time and the non-operational time of the air conditioning apparatus 400.

Note that the above description has been given in terms of an example configuration that sends the temperature information stored in the indoor unit 82 to the outdoor unit 81, and the outdoor unit 81 controls the rotational speed of the compressor 310. However, configuring such that the indoor unit 82 directly controls the rotational speed of the compressor 310 also provides the same or similar advantages.

Although the fifth embodiment has been described in terms of an example configuration of the air conditioning apparatus 400 including the outdoor unit 81 and the indoor unit 82, the same or similar advantages can be provided by any apparatus that changes, by heat exchange, the temperature of a medium having a constant volume and voluminal size using a compression and expansion action of a refrigerant, such as a hot-water supply apparatus including a heat exchanger (not illustrated) that provides the heat of refrigerant to water, in place of the indoor unit 82.

The configurations described in the foregoing embodiments are merely examples of various aspects of the present invention. These configurations may be combined with a known other technology, and moreover, a part of such configurations may be omitted and/or modified without departing from the spirit of the present invention.

1. An alternating current to direct current (AC/DC) converter comprising:
a first rectifier and a second rectifier each coupled through a reactor to an alternating current (AC) power supply;
a switch arm including two switches coupled in series with each other arranged on an output side of the first rectifier; and
two capacitors coupled in series with each other arranged on an output side of the second rectifier,
wherein a connection point between the two capacitors is coupled to a connection point between the two switches
the second rectifier includes two diode arms each including two diodes coupled in series with each other,
in one diode arm of the two diode arms, each of the two diodes is coupled in parallel with a switch that controls a current to flow in a direction opposite to a current that flows through a corresponding one of the two diodes,
the switch that controls a current to flow in a direction opposite to a current that flows through a corresponding one of the two diodes is configured using a wide bandgap semiconductor, and
the two switches included in the switch arm are each configured using a silicon semiconductor.

2. The AC/DC converter according to claim 1, wherein each of the two switches is coupled in parallel with a diode in which a current flows in a direction opposite to a current that flows through a corresponding one of the two switches.

3. (canceled)

4. The AC/DC converter according to claim 1,
wherein
the second rectifier includes two diode arms each including two diodes coupled in series with each other, and
each of the two diodes is coupled in parallel with a switch that controls a current to flow in a direction opposite to a current that flows through a corresponding one of the two diodes.

5. The AC/DC converter according to claim 1, wherein the switch that controls a current to flow in a direction opposite to a current that flows through a corresponding one of the two diodes is configured using a field effect transistor.

6. (canceled)

7. The AC/DC converter according to claim 1,
wherein
one of the two diodes included in one of the two diode arms and one of the two diodes included in another one of the two diode arms each have anodes coupled to each other, and
each of the diodes each having anodes coupled to each other is coupled in parallel with a switch that controls a current to flow in a direction opposite to a current that flows through that diode.

8. A module:
that is included in an alternating current to direct current (AC/DC) converter comprising: a first rectifier and a second rectifier each coupled through a reactor to an alternating current (AC) power supply; a switch arm including two switches coupled in series with each other arranged on an output side of the first rectifier; and two capacitors coupled in series with each other arranged on an output side of the second rectifier, and a connection point between the two capacitors is coupled to a connection point between the two switches,
the module comprising a second rectifier and a switch arm,
wherein
the second rectifier includes
two diode arms each including two diodes coupled in series with each other,
an input terminal for a single-phase alternating current, and
an output terminal to which a voltage that is rectified by the two diode arms is applied.

9. The module according to claim 8, comprising:
two terminals each of which is coupled with corresponding one of both ends of the switch arm.

10. The module according to claim 8, wherein each of the two switches included in the switch arm is coupled in parallel with a diode that allows a current to flow in a direction opposite to a current that flows through a corresponding one of the two switches.

11. The module according to claim 8,
wherein
each of the two diodes is coupled in parallel with a switch that controls to flow a current in a direction opposite to a current that flows through a corresponding one of the two diodes, and
the switch is configured by a field effect transistor.

12. The module according to claim 10, wherein the two switches included in the switch arm are each configured using a wide bandgap semiconductor.

13. The module according to claim 8, wherein the two switches included in the switch arm are included inside the module.

14. The module according to claim 8,
wherein
each of the two diodes is coupled in parallel with a switch that controls a current to flow in a direction opposite to a current that flows through a corresponding one of the two diodes,
the switch that controls a current to flow in a direction opposite to a current that flows through a corresponding one of the two diodes is configured using a wide bandgap semiconductor, and
the two switches included in the switch arm are each configured using a silicon semiconductor.

15. The module according to claim 8, wherein the two switches included in the switch arm are correspondingly driven by drive circuits that are powered by a common power supply.

16. The module according to claim 8,
wherein
an anode of one of the two diodes included in one of the two diode arms, and an anode of one of the two diodes included in another one of the two diode arms are coupled to each other,
each of the diodes the anodes of which are coupled to each other, is coupled in parallel with a switch that controls a current to flow in a direction opposite to a current that flows through that diode, and
the switch is included inside the module.

17. A power conversion device comprising:
an inverter coupled to an output end of the AC/DC converter according to claim 1; and
an electric motor driven by an output of the inverter,
wherein the power conversion device selects either to control the two switches included in the switch arm, or to control the switches each coupled to the two diodes included in the two diode arms, depending on a rotational speed of the electric motor.

18. An air conditioning apparatus comprising:
the power conversion device according to claim 17; and
a compressor including the electric motor,
wherein a rotational speed of the compressor is controlled to adjust the amount of refrigerant compressed by the compressor and circulating through a refrigerant pipe.

19. An air conditioning apparatus comprising:
the power conversion device according to claim 17;
an outdoor unit including the electric motor as a compressor;
an indoor unit to store a target temperature specified and a detection temperature; and
a refrigerant pipe to circulate a refrigerant between the outdoor unit and the indoor unit,
wherein a rotational speed of the compressor is controlled based on information on the temperatures stored in the indoor unit.
